(19) United States
(12) Patent Application Publication
(10) Pub. No.: US 2024/0334479 A1
(43) Pub. Date: Oct. 3, 2024

(54) METHOD FOR CHANNEL OCCUPANCY TIME SHARING AND TERMINAL DEVICE

(71) Applicant: GUANGDONG OPPO MOBILE TELECOMMUNICATIONS CORP., LTD., Dongguan (CN)

(72) Inventor: Yi DING, Dongguan (CN)

(21) Appl. No.: 18/738,797

(22) Filed: Jun. 10, 2024

Related U.S. Application Data
(63) Continuation of application No. PCT/CN2021/139763, filed on Dec. 20, 2021.

(51) Int. Cl. H04W 74/0808; H04W 74/00; H04W 92/18

(52) U.S. Cl. CPC H04W 74/0808; H04W 74/002; H04W 92/18

(57) ABSTRACT

A method and a terminal device are provided. The method includes the following. A second terminal device receives a resource indication transmitted by a first terminal device, and determines, according to the resource indication, a transmission resource(s) indicated by the first terminal device. The second terminal device performs listen before talk (LBT) according to the transmission resource(s) indicated. A COT is shared to the first terminal device in the case where the LBT performed by the second terminal device succeeds.

### CROSS-REFERENCE TO RELATED APPLICATION(S)

This application is a continuation of International Application No. PCT/CN2021/139763, filed Dec. 20, 2021, the entire disclosure of which is hereby incorporated by reference.

### TECHNICAL FIELD

This disclosure relates to the technical field of communications, and in particular, to the technical field of sidelink (SL) transmission.

### BACKGROUND

Sidelink (SL) transmission refers to direct transmission between terminal devices through SL, which is different from a mode in which communication data is received or transmitted by a base station in a conventional cellular system. SL transmission, i.e., a vehicle to vehicle (V2V) mode, is also supported in a vehicle to everything (V2X) system. Therefore, SL transmission has relatively high spectral efficiency and relatively low transmission delay.

In addition, some countries and regions classify some spectrums as spectrums shareable for communication of radio devices, i.e., unlicensed spectrums. In different communication systems, communication devices are not required to apply for an exclusive spectrum license from government to use unlicensed spectrums as long as these communication devices satisfy regulatory requirements on unlicensed spectrums set by the countries or regions. For example, a wireless fidelity (WIFI) system is deployed on unlicensed spectrums. Since unlicensed spectrums can be used without government authorization, a listen before talk (LBT) mechanism needs to be followed in case of using unlicensed spectrums.

In unlicensed spectrums, all communication devices need to perform LBT before signal transmission. That is, before a communication device performs signal transmission on a channel in an unlicensed spectrum, the communication device needs to sense the channel. Only if the channel is sensed to be idle, the communication device can perform signal transmission. Therefore, in the case where the terminal device on SL operates in an unlicensed frequency band, a user equipment (UE) on SL also needs to perform LBT. In the case where LBT succeeds, the UE can perform channel access and data transmission.

However, generally, in an unlicensed sidelink (SL-U) transmission system, there may be problems that stations may be hidden from each other. In an example, UE1 communicates with UE2, UE3 communicates with UE4, and UE1 and UE3 are far away from each other, and thus during LBT, UE1 cannot perceive whether a channel is occupied by UE3 and UE3 cannot perceive whether a channel is occupied by UE1. In this case, a channel may be sensed to be idle by both UE1 and UE3, and accordingly both UE1 and UE3 may successfully access the channel. If UE1 and UE3 simultaneously access the channel and perform transmission, transmission performed by UE3 may interfere with transmission from UE1 to UE2, resulting in a decrease in communication reliability.

### SUMMARY

A method for channel occupancy time (COT) sharing and a terminal device are provided in the disclosure.

The following technical solutions are provided in the disclosure.

In an aspect, a method for COT sharing is provided. The method includes the following. A second terminal device receives a resource indication transmitted by a first terminal device, and determines, according to the resource indication, at least one transmission resource indicated by the first terminal device. The second terminal device performs listen before talk (LBT) according to the at least one transmission resource indicated. A COT is shared to the first terminal device in the case where the LBT performed by the second terminal device succeeds.

In another aspect, a terminal device is provided. The terminal device includes a transceiver, a processor coupled with the transceiver, and a memory storing a computer program which, when executed by the processor, causes the terminal device to: receive a resource indication transmitted by another terminal device, and determine, according to the resource indication, at least one transmission resource indicated by the other terminal device; perform LBT according to the at least one transmission resource indicated; and share a COT to the other terminal device in the case where the LBT performed by the terminal device succeeds.

In another aspect, a terminal device is provided. The terminal device includes a transceiver, a processor coupled with the transceiver, and a memory storing a computer program which, when executed by the processor, causes the terminal device to: transmit a resource indication indicative of at least one transmission resource; obtain a COT shared by another terminal device, where the COT is shared to the terminal device by the other terminal device after LBT performed by the other terminal device according to the at least one transmission resource indicated by the resource indication succeeds; perform channel access according to the COT shared by the other terminal device.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

FIG. 1A and FIG. 1B are diagrams illustrating architectures of systems to which embodiments of the disclosure are applied.

FIG. 2 illustrates an application scenario in embodiments of the disclosure.

FIG. 3 is a schematic flow chart illustrating a method for channel occupancy time (COT) sharing according to embodiment 1 of the disclosure.

FIG. 4 is a schematic diagram illustrating that different channel access schemes are applied in a COT shared by a base station in different scenarios.

FIG. 5 illustrates a specific example of embodiment 1 of the disclosure.

FIG. 6 is a schematic module diagram of a terminal device provided in embodiment 2 of the disclosure.

FIG. 7 is a schematic module diagram of a terminal device provided in embodiment 3 of the disclosure.

FIG. 8 is a schematic structural diagram of a terminal device provided in embodiment 4 of the disclosure.

### DETAILED DESCRIPTION

In order to make purposes, technical solutions, and advantages of the disclosure clearer, the following will further describe in detail the disclosure with reference to accompanying drawings and embodiments. It may be understood that, embodiments described herein are merely for explaining, rather than limiting, the disclosure. However, the disclosure can be implemented in many different forms and is not limited to the embodiments described herein. On the contrary, these embodiments are provided for a more thorough and comprehensive understanding of the disclosure.

Unless otherwise defined, all technical and scientific terms used herein have the same meaning as commonly understood by those skilled in the art of the disclosure. The terms used herein in the disclosure are for the purpose of describing specific embodiments only and are not intended to limit the disclosure.

It may be understood that, the terms “system” and “network” in this disclosure are often used interchangeably. The term “and/or” in this disclosure is simply an illustration of an association relationship of associated objects, indicating that three relationships can exist, for example, A and/or B can indicate the existence of A alone, A and B together, and B alone. In addition, the character “/” in this disclosure generally indicates that associated objects are in an “or” relationship.

The technical solutions in embodiments of the disclosure can be applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (Wi-Fi), a next-generation communication system, or other communication systems.

Generally speaking, a conventional communication system supports a limited number of connections and therefore is easy to implement. However, with development of communication technology, a mobile communication system not only supports conventional communication but also supports, for example, device to device (D2D) communication, machine to machine (M2M) communication, machine type communication (MTC), and vehicle to vehicle (V2V) communication. Embodiments herein can also be applicable to these communication systems.

Optionally, a communication system in embodiments of the disclosure can be applicable to a carrier aggregation (CA) scenario, a dual connectivity (DC) scenario, and a standalone (SA) scenario.

The spectrum applied is not limited in embodiments of the disclosure. For example, the embodiments of the disclosure can be applied to a licensed spectrum or to an unlicensed spectrum.

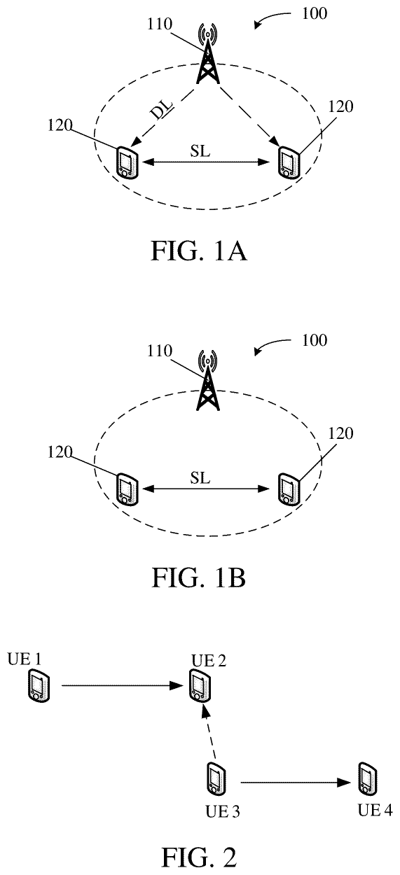

Refer to FIG. 1A and FIG. 1B, where FIG. 1A and FIG. 1B each illustrate a wireless communication system 100 to which embodiments of the disclosure are applied. The wireless communication system 100 is a sidelink (SL) transmission system.

For SL transmission, two transmission modes, i.e., mode A and mode B, are defined in 3rd generation partnership project (3GPP).

Mode A: as illustrated in FIG. 1A, a terminal device 120 is an SL user equipment (UE), and a network device 110 allocates a transmission resource(s) to the terminal device 120. The terminal device 120 performs data transmission on SL according to a resource(s) allocated by the network device 110. The network device 110 may allocate to the terminal device 120 a resource(s) for single transmission or a resource(s) for semi-static transmission.

Mode B: as illustrated in FIG. 1B, the terminal device 120 selects at least one resource from a resource pool to perform data transmission. Specifically, the terminal device 120 may select a transmission resource(s) from a resource pool through sensing or random selection.

The terminal device 120 may be a terminal device in D2D or a vehicle terminal in internet of vehicles (IoV).

Optionally, the communication system 100 may include multiple network devices, and the other number of terminal devices may be included in a coverage range of each of the multiple network devices, which is not be limited in embodiments of the disclosure.

The network device 110 can provide a communication coverage for a specific geographical area and communicate with UEs in the coverage area. The network device 110 may be a base transceiver station (BTS) in the GSM or CDMA system, or may be a Node B (NB) in the WCDMA system, or may be an evolved Node B (eNB or eNodeB) in the LTE system, or a radio controller in a cloud radio access network (CRAN). Alternatively, the network device may be a relay station, an access point (AP), an in-vehicle device, a wearable device, a network side device in a 5th generation (5G) network, or a network device in a future evolved public land mobile network (PLMN), or the like.

The terminal device 120 may be mobile or fixed. The terminal device 120 may refer to an access terminal, a UE, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a UE in the 5G network, a UE in the future evolved PLMN, etc.

The following embodiments of the disclosure will explain in detail how to avoid a problem that terminal devices may be hidden from each other during SL transmission, thereby improving communication reliability.

### Embodiment 1

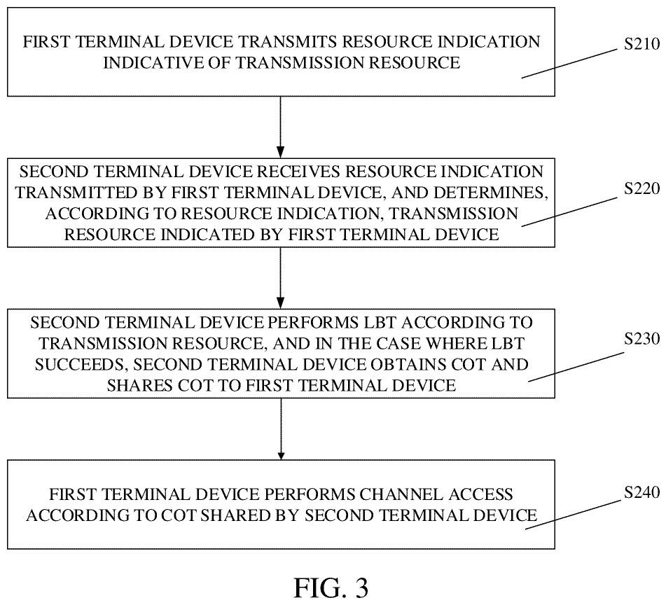

Referring to FIG. 3, a method for channel occupancy time (COT) sharing is provided in embodiment 1 of the disclosure. The method includes the following.

At S210, a first terminal device transmits a resource indication indicative of a transmission resource(s).

At S220, a second terminal device receives the resource indication transmitted by the first terminal device, and determines, according to the resource indication, the transmission resource(s) indicated by the first terminal device.

At S230, the second terminal device performs listen before talk (LBT) according to the transmission resource(s), and in the case where the LBT succeeds, the second terminal device obtains a COT and shares the COT to the first terminal device.

At S240, the first terminal device performs channel access according to the COT shared by the second terminal device.

Referring to FIG. 2, an application scenario of embodiment 1 of the disclosure is illustrated. In SL transmission illustrated in FIG. 2, the first terminal device (UE1) communicates with the second terminal device (UE2), UE1 transmits information or data to UE2, a third terminal device (UE3) communicates with a fourth terminal device (UE4), and UE3 transmits information or data to UE4. UE1 and UE3 are far away from each other and thus during LBT, UE1 cannot perceive whether a channel is occupied by UE3 and UE3 cannot perceive whether a channel is occupied by UE1.

In the case where UE1 and UE3 both perform LBT and a channel is sensed to be idle by both UE1 and UE3, both UE1 and UE3 may successfully access the channel. However, in the case where UE1 and UE3 simultaneously access a channel and perform transmission, transmission performed by UE3 may interfere with transmission from UE1 to UE2, resulting in a decrease in communication reliability.

In order to solve the technical problem, in embodiment 1 of the disclosure, UE2 performs LBT, and since UE2 and UE3 are close to each other, UE2 and UE3 are not hidden from each other, and thus UE2 can know whether a channel is occupied by UE3. Therefore, the technical problem that UE1 and UE3 may be hidden from each other is solved, and the technical effect of improving communication reliability is achieved. Optionally, the LBT is type 1 LBT.

Optionally, at S210, the first terminal device transmits the resource indication indicative of the transmission resource(s) as follows. The first terminal device indicates the transmission resource(s) via sidelink control information (SCI). That is, the transmission resource(s) indicated includes a transmission resource(s) indicated by the first terminal device via the SCI.

Optionally, the transmission resource(s) indicated includes a transmission resource(s) for a same transport block (TB) indicated by the first terminal device via the SCI; and/or, a transmission resource(s) for different TBs indicated by the first terminal device via the SCI.

Optionally, the SCI includes first SCI or second SCI. The first SCI is carried in a physical sidelink control channel (PSCCH), and the second SCI is carried in a physical sidelink shared channel (PSSCH).

Optionally, the transmission resource(s) indicated by the first terminal device is a time-frequency resource(s).

Two types of LBT mechanism are included.

### Type 1 LBT

A communication device first senses a channel for a defer duration Td. After sensing the channel to be idle during sensing slot durations of the defer duration Td and after N is equal to 0 in the following step, LBT succeeds, and the communication device may occupy the channel and perform data transmission. Otherwise, the communication device cannot access the channel or continues to attempt to perform channel access.

Step 1, set N=Ninit, where Ninit is a random number uniformly distributed between 0 and CWp, and go to step 4.

Step 2, if N>0, the communication device decreases N by 1, i.e., set N=N−1.

Step 3, sense a channel for an additional sensing slot duration, and if the additional sensing slot duration is idle, go to step 4; else, go to step 5.

Step 4, if N=0, stop; else, go to step 2.

Step 5: sense the channel until either a busy sensing slot is detected within an additional defer duration Td or all sensing slots of the additional defer duration Td are detected to be idle.

Step 6: if the channel is sensed to be idle during all the sensing slot durations of the additional defer duration Td, go to step 4, else, go to step 5.

The steps above are performed in sequence unless specific statement for skipping. Exemplarily, a sensing slot duration above is marked as Tsl, which is of 9 μs.

Ninit is a random number uniformly distributed between 0 and CWp. CWp is related to a channel access priority class for the communication device. CWp may also be referred to as a contention window for a given priority class or a contention window determined according to a priority class. The communication device determines a value of CWmin,p, a value of CWmax,p, and allowed CWp sizes according to the channel access priority class, i.e., determines a minimum value, a maximum value, and possible values of a contention window according to a priority class. For example, as illustrated in Table 1, in the case where the channel access priority class for the communication device is 3, the minimum value of the contention window used by the communication device is 15, the maximum value of the contention window used by the communication device is 1023, and possible values of the contention window used by the communication device are {15, 31, 63, 127, 255, 511, 1023}. In fact, the communication device maintains a contention window size for each priority class, adjusts a contention window for each priority class according to a certain rule before performing step 1 each time, and determines, according to the channel access priority class, a contention window used for LBT performed this time, so that Ninit is determined.

For example, the communication device maintains CW1, CW2, CW3, and CW4. In the case where the communication device performs the type 1 LBT, the communication device increases each of CW1, CW2, CW3, and CW4 to the next higher allowed value before step 1. In the case where the channel access priority class for the communication device this time is 1, the communication device performs the type 1 LBT using the adjusted CW1.

TABLE 1

| channel | | | | | |
|---|---|---|---|---|---|
| access | | | | | |
| priority | | | | | allowed CWp |
| class (p) | mp | CWmin, p | CWmax, p | Tmcot, p | sizes |
| 1 | 2 | 3 | 7 | 2 ms | {3, 7} |
| 2 | 2 | 7 | 15 | 4 ms | {7, 15} |
| 3 | 3 | 15 | 1023 | 6 or 10 ms | {15, 31, 63, 127, |
| | | | | | 255, 511, 1023} |
| 4 | 7 | 15 | 1023 | 6 or 10 ms | {15, 31, 63, 127, |
| | | | | | 255, 511, 1023} |

Td=Tf+mp*Tsl, where Tf is equal to 16 μs, and mp is related to a channel access priority class. For example, according to Table 1, a mp corresponding to a priority class may be determined.

After the communication device performs the above steps and the LBT succeeds, in the case where the communication device does not access the channel immediately, when the communication device needs to perform data transmission, the communication device needs to perform channel access, but the communication device does not need to perform all the steps of the type 1 LBT again and only needs to sense whether the channel is occupied in a duration that is Td plus at least one Tsl. In the case where the channel is sensed to be idle in the duration that is Td plus at least one Tsl, the communication device can directly access the channel and performs signal transmission.

After LBT succeeds and the communication device accesses a channel, a total time of occupying the channel by the communication device is referred to as a COT. In the COT, the communication device may perform contiguous transmission or non-contiguous transmission, but a total transmission time does not exceed Tmcot,p. Tmcot,p is related to a channel access priority class, which may be found in Table 1 for example.

### Type 2 LBT

Unlike the type 1 LBT, for the type 2 LBT, the communication device is only required to sense a channel for a fixed duration, and in the case where sensing slots of the fixed duration are sensed to be idle, the communication device may directly access the channel. Specifically, the type 2 LBT is classified into three sub-types: type 2A LBT, type 2B LBT, and type 2C LBT.

Type 2A LBT: the communication device may sense a channel for a duration of 25 μs (denoted as Tshort), and in the case where all sensing slots of Tshort are sensed to be idle, the communication device may directly access the channel.

Type 2B LBT: the communication device may sense a channel for a duration of 16 μs (denoted as Tf), and in the case where sensing slots of Tf are sensed to be idle, the communication device may directly access the channel.

Type 2C LBT: the communication device may not perform LBT and directly performs channel access. This type can only be applied to the case that a gap between this transmission and last transmission is less than or equal to 16 μs and a duration of this transmission is at most 584 μs. For example, a criterion for determining whether a sensing slot is busy is that the sensing slot is busy for 4 μs if the duration of the sensing slot is 9 μs. Otherwise, the sensing slot is determined to be idle. Alternatively, the criterion for determining whether a sensing slot is busy is that energy or power monitored in the sensing slot is greater than or equal to a threshold q.

Optionally, in embodiments of the disclosure, after the LBT performed by the second terminal device succeeds, in the case where the second terminal device does not perform channel access immediately, when the second terminal device needs to perform channel access, the second terminal device only needs to sense whether the channel is occupied in the duration that is Td plus at least one Tsl. In the case where the channel is sensed to be idle in the duration that is Td plus at least one Tsl, the second terminal device can directly access the channel and share the COT to the first terminal device.

Optionally, at S230, the second terminal device performs the LBT according to the transmission resource(s), and in the case where the LBT succeeds, the second terminal device obtains the COT and shares the COT to the first terminal device, as follows. The second terminal device shares the COT to the first terminal device through a PSCCH, a PSSCH, or a physical sidelink feedback channel (PSFCH) in the case where the LBT performed by the second terminal device succeeds.

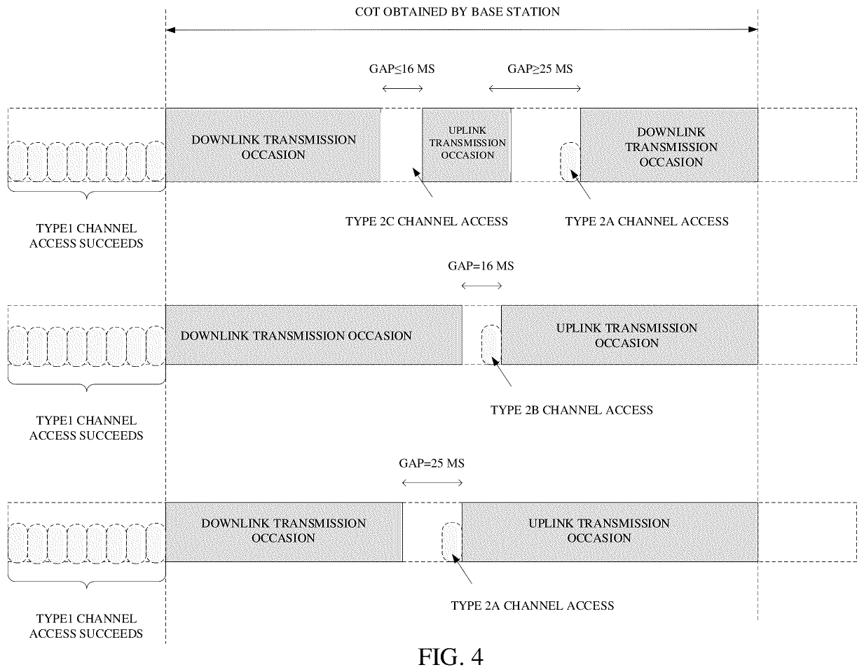

After the LBT succeeds, the communication device further can share the obtained COT to other communication devices. Channel access types applied in different COT sharing scenarios are different. Referring to FIG. 4, COT sharing by a base station side is taken as an example. The base station shares its COT to a terminal device. There is an uplink transmission occasion in the COT obtained by the base station. In the case where a gap between the start of the uplink transmission occasion and the end of a downlink transmission occasion is less than or equal to 16 μs, the terminal device can perform type 2C channel access before uplink transmission. In the case where the gap between the start of the uplink transmission occasion and the end of the downlink transmission occasion is 16 μs, the terminal device (UE) may perform type 2B channel access before uplink transmission. In the case where the gap between the start of the uplink transmission occasion and the end of the downlink transmission occasion is equal to or greater than 25 μs, the UE may perform type 2A channel access before uplink transmission. In addition, there may be multiple downlink-to-uplink switch points in the COT obtained by the base station. After the base station shares the obtained COT to the UE and after the UE performs uplink transmission, the base station may also perform channel sensing in the COT through type 2 channel access such as type 2A channel access, and restart downlink transmission in the case where the channel sensing succeeds.

Optionally, at S230, besides that the second terminal device indicates COT sharing to the first terminal device, the second terminal device further performs at least one of: reporting a measurement result to the first terminal device, where the measurement result includes, but is not limited to, at least one of sidelink reference signal received power (SL-RSRP) or channel state information (CSI); indicating a type of the LBT to the first terminal device, such as type 2A, type 2B, or type 2C; indicating a remaining COT duration to the first terminal device; or indicating a channel access priority class to the first terminal device.

Optionally, the second terminal device is a receiving terminal of the first terminal device, or the second terminal device is a group leader terminal device. For example, the group leader terminal device is a terminal device for scheduling among a set of terminal devices.

Optionally, the second terminal device performs the LBT according to the transmission resource(s) indicated as follows. The second terminal device performs the LBT according to at least one of the transmission resource(s) indicated.

For example, the second terminal device performs the LBT according to a transmission resource(s) for next transmission indicated by the first terminal device. Optionally, the second terminal device performs the LBT according to a transmission resource(s) for a same TB indicated by the first terminal device. The transmission resource(s) for the same TB does not include a transmission resource(s) indicating COT sharing

Optionally, the case that the second terminal device performs the LBT according to the transmission resource(s) indicated further includes the following. The second terminal device performs the LBT on a resource block (RB) set(s) where the transmission resource(s) indicated is located; and/or the second terminal device performs the LBT before a slot where the transmission resource(s) indicated is located.

For example, the LBT starts to be performed in R slots before the slot where the transmission resource(s) indicated is located. R may be determined by any one of: configuring by a network, preconfiguring, depending on terminal device implementation, R being a preset value specified by standards, or setting R as 1. The RB set refers to that in an unlicensed spectrum system, frequency-domain resources on a carrier are divided into several RB sets, and a guard band is configured between RB sets. For example, one RB set corresponds to a frequency-domain width of 20 MHz. The communication device performs the LBT at a granularity of one RB set, and one RB set may also be referred to as one LBT subband. That is, in the case where the communication device is to perform data transmission on a certain RB set, the communication device needs to perform the LBT on the RB set and performs transmission in the case where the LBT succeeds.

For another example, the second terminal device selects, according to the transmission resource(s) indicated, a transmission resource(s) indicating COT sharing, and performs the LBT before a position where the transmission resource(s) indicating COT sharing is located.

Optionally, the second terminal device may transmit a sharing indication through a PSCCH, a PSSCH, or a PSFCH, where the sharing indication indicates COT sharing. For example, the second terminal device may transmit the sharing indication through the PSCCH, the PSSCH, or the PSFCH.

Optionally, the PSCCH, the PSSCH, or the PSFCH satisfies one of: the PSCCH or the PSSCH being a PSCCH or a PSSCH in a slot that is before the transmission resource(s) indicated or in a slot that is before the transmission resource(s) indicated and belonging to a resource pool, or the PSFCH being a PSFCH in the last slot that has PSFCH configuration and before the transmission resource(s) indicated or in the last slot that has PSFCH configuration and belonging to the resource pool; and/or the PSCCH, the PSSCH, or the PSFCH being located in a same RB set as the transmission resource(s) indicated.

Optionally, the resource pool is a resource pool for the first terminal device or a resource pool for the second terminal device. Exemplarily, the resource pool is a resource pool for the first terminal device or a resource pool for the second terminal device. The resource pool may be a transmission resource pool or a reception resource pool.

Optionally, at S240, the first terminal device performs channel access according to the COT shared by the second terminal device as follows. The first terminal device performs channel access through type 2 LBT in the case where the first terminal device receives from the second terminal device the sharing indication indicating COT sharing; and/or the first terminal device performs channel access through type 1 LBT or does not perform LBT in the case where the first terminal device does not receive from the second terminal device the sharing indication indicating COT sharing.

Optionally, at S240, the first terminal device performs channel access according to the COT shared by the second terminal device as follows. The first terminal device determines, according to the sharing indication indicating COT sharing from the second terminal device, to perform channel access through type 1 LBT, or to perform channel access through type 2 LBT, or not to perform LBT.

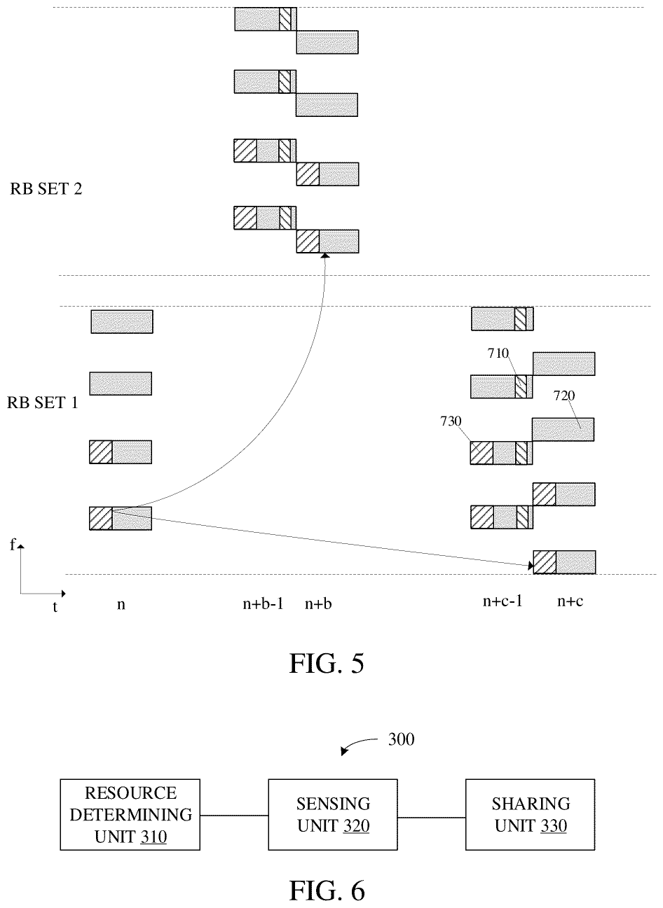

Referring to FIG. 5, a specific example of embodiments of the disclosure is provided. SL transmission is performed between the first terminal device (UE1) and the second terminal device (UE2). UE1 transmits SCI and data to UE2. UE2 shares a COT to UE1. In FIG. 5, the horizontal axis t represents time domain, and the vertical axis f represents frequency domain. In the example, two RB sets are included, i.e., RB set 1 and RB set 2. RB set 1 and RB set 2 each include PSFCH 710, PSSCH 720, and PSCCH 730. UE2 is a receiving terminal of UE1, or UE2 is a group leader terminal device.

UE1 transmits a PSCCH and a PSSCH in slot n, and a time-frequency resource in slot n, a time-frequency resource in slot n+b, and a time-frequency resource in slot n+c are indicated via first SCI in the PSCCH. The three resources are used for transmission of the same TB. Both the PSCCH resource and the PSSCH resource in FIG. 5 are in a comb shape to meet requirements on occupation of unlicensed spectrums and unlicensed bands. UE2 determines, according to the first SCI, a time-frequency resource(s) indicated by UE1 to perform LBT. UE2 can perform the LBT merely according to the resource(s) in slot n+b, or UE2 can perform the LBT according to the resource(s) in slot n+b and the resource(s) in slot n+c.

In the case where UE2 performs the LBT according to the resource(s) in slot n+b, UE2 may perform the type 1 LBT in slot n+b−R, where R is configured by the network or preconfigured. Optionally, in the case where UE2 determines a time-frequency resource(s) indicating COT sharing, that is, UE2 determines to transmit an indication indicating COT sharing through a PSFCH, a PSCCH, or a PSSCH in slot n+b−1, UE2 performs the type 1 LBT before slot n+b−1. UE2 performs the LBT on the RB set 2.

In the case where the LBT performed by UE2 succeeds, UE2 indicates COT sharing through the PSFCH, the PSCCH, or the PSSCH in the RB set 2. Assuming that UE2 indicates COT sharing through the PSFCH, in the example of FIG. 5, slot n+b−1 is the last slot with PSFCH resource configuration before slot n+b, and thus UE2 indicates COT sharing through the PSFCH resource in slot n+b−1. Assuming that UE2 indicates COT sharing through the PSCCH or the PSSCH, in the example of FIG. 5, slot n+b−1 is a slot belonging to the resource pool, and thus UE2 indicates COT sharing through the PSSCH or the PSCCH in slot n+b−1.

In the case where UE2 indicates COT sharing through the PSFCH, the PSFCH resource carries a 1-bit indication. In the case where UE1 receives the indication, UE1 performs channel access through the type 2 LBT. In the case where UE1 does not receive the indication, UE1 performs channel access through the type 1 LBT or does not perform LBT. Optionally, in the case where the indication indicates a first value, UE1 performs channel access through the type 2 LBT. In the case where the indication indicates a second value, UE1 performs channel access through the type 1 LBT or does not perform LBT. Optionally, in this case, a specific type of the type 2 LBT used by UE1 to perform channel access depends on UE1 implementation, or is configured by the network or preconfigured.

In the case where UE2 indicates COT sharing through the PSCCH or the PSSCH, the PSCCH resource or the PSSCH resource carries the sharing indication, and the sharing indication indicates one or more of: a remaining COT duration, a channel access priority class, and a channel access type (for example, type 2A/2B/2C). In the case where UE1 receives the sharing indication, UE1 performs type 2 channel access. Optionally, in the case where a channel access priority class of UE1 is higher than the channel access priority class in the sharing indication, UE1 performs type 2 channel access. Otherwise, UE1 does not perform LBT, or performs channel access through the type 1 LBT. Optionally, according to the remaining COT duration, UE1 determines to perform channel access through the type 2 LBT, or to perform channel access through the type 1 LBT, or not to perform LBT. In the case where UE1 does not receive the sharing indication, UE1 does not perform LBT or performs channel access through the type 1 LBT. In the case where the PSSCH resource is used, UE2 may also carry a measurement result, e.g., SL-RSRP or CSI, in the PSSCH. Optionally, a type of the type 2 LBT used by UE1 to perform channel access may be determined according to the channel access type in the sharing indication.

In the case where UE2 performs the LBT according to the resource(s) in slot n+c, UE2 may perform the type 1 LBT in slot n+c−R, where R is configured by the network or preconfigured. Optionally, UE2 determines the time-frequency resource(s) indicating COT sharing, that is, UE2 determines to transmit an indication through a PSFCH, a PSCCH, or a PSSCH in slot n+c−1, UE2 performs the type 1 LBT before slot n+c−1. UE2 performs the LBT on the RB set 1.

In the case where the LBT performed by UE2 succeeds, UE2 indicates COT sharing through the PSFCH, the PSCCH, or the PSSCH resource in the RB set 1. Assuming that UE2 indicates COT sharing through the PSFCH, in the example of FIG. 5, slot n+c−1 is the last slot with PSFCH resource configuration before slot n+c, and thus UE2 indicates COT sharing through the PSFCH resource in slot n+c−1. Assuming that UE2 indicates COT sharing through the PSCCH or the PSSCH, slot n+c−1 is a slot belonging to the resource pool, and thus UE2 indicates COT sharing through the PSSCH or the PSCCH in slot n+c−1.

In the case where UE2 indicates COT sharing through the PSFCH, the PSFCH resource carries a 1-bit indication. In the case where UE1 receives the indication, UE1 performs channel access through the type 2 LBT. In the case where UE does not receive the indication, UE1 performs channel access through the type 1 LBT or does not perform LBT. Optionally, in the case where the indication indicates a first value, UE1 performs channel access through the type 2 LBT. In the case where the indication indicates a second value, UE1 performs channel access through the type 1 LBT or does not perform LBT. Optionally, in this case, a specific type of the type 2 LBT used by UE1 to perform channel access depends on UE1 implementation, or is configured by the network or preconfigured.

Specifically, in the case where the PSCCH resource or the PSSCH resource is used, the PSCCH resource or the PSSCH resource carries the sharing indication, and the sharing indication indicates one or more of: a remaining COT duration, a channel access priority class, and a channel access type (for example, type 2A/2B/2C). In the case where UE1 receives the sharing indication, UE1 performs type 2 channel access. Optionally, in the case where a channel access priority class of UE1 is higher than the channel access priority class in the sharing indication, UE1 performs type 2 channel access. Otherwise, UE1 does not perform LBT or performs channel access through the type 1 LBT. Optionally, according to the remaining COT duration, UE1 determines to perform channel access through the type 2 LBT, or to perform channel access through the type 1 LBT, or not to perform LBT. In the case where UE1 does not receive the sharing indication, UE1 does not perform LBT or performs channel access through the type 1 LBT. In the case where the PSSCH resource is used, UE2 may also carry a measurement result, e.g., SL-RSRP or CSI, in the PSSCH. Optionally, a type of the type 2 LBT used by UE1 to perform channel access may be determined according to the channel access type in the sharing indication.

In embodiment 1 of the disclosure, in the case where the LBT performed by the receiving terminal or the group leader terminal device (i.e., UE2) succeeds, the receiving terminal or the group leader terminal device shares the COT to a transmitting terminal (i.e., UE1). UE1 uses the shared COT to perform channel access. Since UE2 can perceive whether UE3 nearby UE2 occupies a channel, only when UE3 does not occupy the channel, the LBT performed by UE2 can succeed and UE2 can share the COT to UE1. Therefore, in the COT obtained by UE1 in this case, UE1 may be not in conflict with UE3, and communication between UE1 and the UE2 may not be interfered by UE3. In this way, the technical problem that UE1 and UE3 may be hidden from each other in the related art is solved, thereby improving communication reliability.

### Embodiment 2

Referring to FIG. 6, a terminal device 300 is provided in embodiment 2 of the disclosure. The terminal device 300 is configured to share a COT. The terminal device 300 corresponds to a second terminal device (UE2) in FIG. 2, i.e., UE2 may be a receiving terminal of a first terminal device (UE1) or a group leader terminal device. The terminal device 300 includes a resource determining unit 310, a sensing unit 320, and a sharing unit 330. The resource determining unit 310 is configured to receive a resource indication transmitted by a first terminal device, and determine, according to the resource indication, a transmission resource(s) indicated by the first terminal device. The sensing unit 320 is configured to perform LBT according to the transmission resource(s) indicated. The sharing unit 330 is configured to share a COT to the first terminal device in the case where the LBT performed by the sensing unit 320 succeeds.

Optionally, the transmission resource(s) indicated includes: a transmission resource(s) indicated by the first terminal device via SCI.

Optionally, the transmission resource(s) indicated includes: a transmission resource(s) for a same TB indicated by the first terminal device via the SCI; or a transmission resource(s) for different TBs indicated by the first terminal device via the SCI.

Optionally, the SCI includes first SCI or second SCI, where the first SCI is carried in a PSCCH, and the second SCI is carried in a PSSCH.

Optionally, the sensing unit 320 is specifically configured to perform the LBT according to at least one of the transmission resource(s) indicated.

Optionally, the sensing unit 320 is further specifically configured to: perform the LBT according to a transmission resource(s) for next transmission indicated by the first terminal device; or perform the LBT according to the transmission resource(s) for the same TB indicated by the first terminal device. The transmission resource(s) for the same TB does not include a transmission resource(s) indicating COT sharing.

Optionally, the sensing unit 320 is further specifically configured to: perform the LBT on an RB set(s) where the transmission resource(s) indicated is located; or perform the LBT before a slot where the transmission resource(s) indicated is located; or perform the LBT before a position where a transmission resource(s) indicating COT sharing and determined by the second terminal device according to the transmission resource(s) indicated is located.

Optionally, the sharing unit 330 is specifically configured to share the COT with the first terminal device through a PSCCH, a PSSCH, or a PSFCH in the case where the LBT performed by the sharing unit 330 succeeds.

Optionally, the PSCCH, the PSSCH, or the PSFCH satisfies one of: the PSCCH or the PSSCH being a PSCCH or a PSSCH in a slot that is before the transmission resource(s) indicated or in a slot that is before the transmission resource(s) indicated and belonging to a resource pool, or the PSFCH being a PSFCH in the last slot that has PSFCH configuration and before the transmission resource(s) indicated or in the last slot that has PSFCH configuration and belonging to the resource pool; and/or the PSCCH, the PSSCH, or the PSFCH being located in a same RB set as the transmission resource(s) indicated.

Optionally, besides that the sharing unit 320 is configured to indicate COT sharing to the first terminal device (UE1), the sharing unit 320 is further configured to perform at least one of: reporting a measurement result to the first terminal device; indicating a type of the LBT to the first terminal device; indicating a remaining COT duration to the first terminal device; or indicating a channel access priority class to the first terminal device.

For details not described in embodiment 2, reference can be made to the same or corresponding parts in embodiment 1, which are not repeated herein.

### Embodiment 3

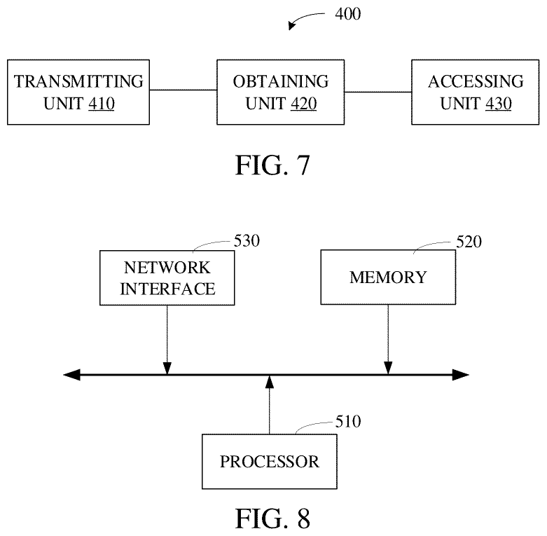

Referring to FIG. 7, a terminal device 400 is provided in embodiment 3 of the disclosure. The terminal device 400 is configured to receive a COT shared. The terminal device 400 corresponds to a first terminal device (UE1) in FIG. 2. The terminal device 400 includes a transmitting unit 410, an obtaining unit 420, and an accessing unit 430. The transmitting unit 410 is configured to transmit a resource indication indicative of a transmission resource(s). The obtaining unit 420 is configured to obtain a COT shared by a second terminal device. The COT is shared with the transmitting unit by the second terminal device after LBT performed by the second terminal device according to the transmission resource(s) indicated by the resource indication succeeds. The accessing unit 430 is configured to perform channel access according to the COT shared by the second terminal device.

Optionally, the transmitting unit 410 is specifically configured to indicate the transmission resource(s) via side control information (SCI).

Optionally, the transmitting unit 410 is further specifically configured to: indicate a transmission resource(s) for a same transport block (TB) via the SCI; or indicate a transmission resource(s) for different TBs via the SCI.

Optionally, the SCI includes first SCI or second SCI, where the first SCI is carried in a PSCCH, and the second SCI is carried in a PSSCH.

Optionally, the accessing unit 420 is specifically configured to perform channel access through type 2 LBT in response to reception of a sharing indication indicating COT sharing from the second terminal device; and/or the accessing unit 420 is specifically configured to perform channel access through type 1 LBT or configured not to perform LBT in response to no reception from the second terminal device of the sharing indication indicating COT sharing.

Optionally, the accessing unit 420 is specifically configured to determine, according to a sharing indication indicating COT sharing from the second terminal device, to perform channel access through type 1 LBT, or to perform channel access through type 2 LBT, or not to perform LBT.

For details not described in embodiment 3, reference can be made to the same or corresponding parts in embodiment 1 and embodiment 2, which are not repeated herein.

### Embodiment 4

Refer to FIG. 8, where FIG. 8 is a schematic structural diagram of a terminal device 500 provided in embodiment 4 of the disclosure. The terminal device 500 includes a processor 510, a memory 520, and a network interface 530. The processor 510 is in communication connection with the memory 520 through a bus system.

The memory 520 is a computer-readable storage medium on which programs that can be run on the processor 510 are stored. The processor 510 is configured to invoke the programs stored in the memory 520 to perform the corresponding process implemented by the first terminal device in the method for COT sharing provided in embodiment 1 or the corresponding process implemented by the second terminal device in the method for COT sharing provided in embodiment 1, and is configured to transmit a processing result through the network interface 530.

The processor 510 may be a separate component, or may be a collective term of multiple processing elements. For example, the processor 510 may be a central processing unit (CPU) or an application specific integrated circuit (ASIC), or may be configured to be one or more integrated circuits for implementing the above methods, such as at least one digital signal processor (DSP), at least one field programmable gate array (FPGA), etc.

Those skilled in the art can appreciate that in the above one or more examples, all or part of the above illustrated functions can be implemented through software, hardware, firmware, or any other combination thereof. When implemented by software, all or part of the above functions can be implemented by a processor performing software instructions. The software instructions may be composed with corresponding software modules. The software module can be stored in a computer-readable storage medium. The computer-readable storage medium may be any available medium that can be accessed by a computer, or a data storage device such as a server or a data center that is integrated by one or more available media. The available medium may be a magnetic medium (such as a soft disc, a hard disc, or a magnetic tape), an optical medium (such as a digital video disc (DVD)), or a semiconductor medium (such as a solid state disk (SSD)), etc. The computer-readable storage medium includes, but is not limited to, a random access memory (RAM), a flash memory, a read-only memory (ROM), an erasable programmable read-only memory (EPROM), an electrically EPROM (EEPROM), a register, a hard disc, a mobile hard disc, or a compact disc read-only memory (CD-ROM), or a storage medium with any other forms known in this field. An exemplary computer-readable storage medium is coupled to the processor, so that the processor can read information from the computer-readable storage medium and can write information to the computer-readable storage medium. The computer-readable storage medium can also be a part of the processor. The processor and the computer-readable storage medium may be located in an ASIC. In addition, the ASIC may be located in an access network device, a target network device, or a core network device. The processor and the computer-readable storage medium may also be presented as discrete components in the access network device, the target network device, or the core network device. When implemented by software, all or part of the above functions can be implemented in the form of a computer program product. The computer program product includes one or more computer instructions. When the computer program instructions are loaded and executed on a computer or a chip, all or part of the processes or functions of specific embodiments of the disclosure are performed. The computer can be a general-purpose computer, a special-purpose computer, a computer network, or other programmable apparatuses. The computer program instructions can be stored in a computer-readable storage medium, or transmitted from one computer-readable storage medium to another computer-readable storage medium. For example, the computer instruction can be transmitted from one web site, computer, server, or data center to another web site, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc.

The embodiments described above illustrate but do not limit the disclosure, and those of skill in the art can design multiple alternative embodiments within the scope of the claims. It may be appreciated by those skilled in the art that the disclosure is not limited to the exact structures described above and illustrated in the accompanying drawings, and that various changes, modifications, equivalent substitutions, improvements, and the like may be made without departing from the scope of the disclosure as defined by the appended claims. Therefore, any modifications and variations made in light of the concepts and principles of the disclosure are within the scope of the disclosure as defined by the appended claims.

What is claimed is:

1. A method for channel occupancy time (COT) sharing, comprising:
receiving, by a second terminal device, a resource indication transmitted by a first terminal device, and determining, by the second terminal device according to the resource indication, at least one transmission resource indicated by the first terminal device;
performing, by the second terminal device, listen before talk (LBT) according to the at least one transmission resource indicated; and
sharing a COT to the first terminal device in the case where the LBT performed by the second terminal device succeeds.

2. The method of claim 1, wherein the at least one transmission resource indicated comprises: at least one transmission resource indicated by the first terminal device via sidelink control information (SCI).

3. The method of claim 2, wherein the at least one transmission resource indicated comprises:
at least one transmission resource for a same transport block (TB) indicated by the first terminal device via the SCI; or
at least one transmission resource for different TBs indicated by the first terminal device via the SCI.

4. The method of claim 2, wherein
the SCI comprises first SCI, wherein the first SCI is carried in a physical sidelink control channel (PSCCH).

5. The method of claim 1, wherein performing, by the second terminal device, the LBT according to the at least one transmission resource indicated, comprises:
performing, by the second terminal device, the LBT according to at least one of the at least one transmission resource indicated.

6. The method of claim 1, wherein performing, by the second terminal device, the LBT according to the at least one transmission resource indicated, further comprises:
performing, by the second terminal device, the LBT on at least one resource block (RB) set where the at least one transmission resource indicated is located; or
performing, by the second terminal device, the LBT before a slot where the at least one transmission resource indicated is located; or
selecting, by the second terminal device according to the at least one transmission resource indicated, at least one transmission resource indicating COT sharing, and performing, by the second terminal device, the LBT before a position where the at least one transmission resource indicating COT sharing is located.

7. The method of claim 1, wherein sharing, by the second terminal device, the COT to the first terminal device in the case where the LBT performed by the second terminal device succeeds, comprises:
sharing, by the second terminal device, the COT to the first terminal device through a PSCCH or a physical sidelink shared channel (PSSCH) in the case where the LBT performed by the second terminal device succeeds.

8. The method of claim 7, wherein the PSCCH or the PSSCH satisfies one of:
the PSCCH or the PSSCH being located in a same RB set as the at least one transmission resource indicated.

9. The method of claim 1, wherein besides that the second terminal device indicates COT sharing to the first terminal device, the second terminal device further performs at least one of:
indicating a remaining COT duration to the first terminal device; or
indicating a channel access priority class to the first terminal device.

10. The method of claim 1, wherein the second terminal device is a receiving terminal of the first terminal device.

11. A terminal device, comprising:
a transceiver;
a processor coupled to the transceiver; and
a memory storing a computer program which, when executed by the processor, causes the terminal device to:
receive a resource indication transmitted by another terminal device, and determine, according to the resource indication, at least one transmission resource indicated by the other terminal device;
perform listen before talk (LBT) according to the at least one transmission resource indicated; and
share a channel occupancy time (COT) to the other terminal device in the case where the LBT performed by the terminal device succeeds.

12. The terminal device of claim 11, wherein the at least one transmission resource indicated comprises: at least one transmission resource indicated by the other terminal device via sidelink control information (SCI).

13. The terminal device of claim 12, wherein the at least one transmission resource indicated comprises:
at least one transmission resource for a same transport block (TB) indicated by the other terminal device via the SCI; or
at least one transmission resource for different TBs indicated by the other terminal device via the SCI.

14. The terminal device of claim 11, wherein the computer program executed by the processor to cause the terminal device to perform the LBT according to the at least one transmission resource indicated is executed by the processor to cause the terminal device:
perform the LBT on at least one resource block (RB) set where the at least one transmission resource indicated is located; or
perform the LBT before a slot where the at least one transmission resource indicated is located; or
perform the LBT before a position where at least one transmission resource indicating COT sharing that is determined by the other terminal device according to the at least one transmission resource indicated is located.

15. A terminal device, comprising:
a transceiver;
a processor coupled to the transceiver; and
a memory storing a computer program which, when executed by the processor, causes the terminal device to:
transmit a resource indication indicative of at least one transmission resource;
obtain a channel occupancy time (COT) shared by another terminal device, wherein the COT is shared to the terminal device by the other terminal device after listen before talk (LBT) performed by the other terminal device according to the at least one transmission resource indicated by the resource indication succeeds; and
perform channel access according to the COT shared by the other terminal device.

16. The terminal device of claim 15, wherein the computer program executed by the processor to cause the terminal device to transmit the resource indication is executed by the processor to cause the terminal device to indicate the transmission resource via side control information (SCI).

17. The terminal device of claim 16, wherein the computer program executed by the processor to cause the terminal device to transmit the resource indication is executed by the processor to cause the terminal device to: indicate at least one transmission resource for a same transport block (TB) via the SCI; or indicate at least one transmission resource for different TBs via the SCI.

18. The terminal device of claim 16, wherein
the SCI comprises first SCI, wherein the first SCI is carried in a physical sidelink control channel (PSCCH).

19. The terminal device of claim 15, wherein the computer program executed by the processor to cause the terminal device to perform channel access according to the COT shared by the other terminal device is executed by the processor to cause the terminal device to perform at least one of:
performing channel access through type 2 LBT in the case where the terminal device receives from the other terminal device a sharing indication indicating COT sharing; or
performing channel access through type 1 LBT or performing no LBT in the case where the terminal device does not receive from the other terminal device the sharing indication indicating COT sharing.

20. The terminal device of claim 15, wherein the computer program executed by the processor to cause the terminal device to perform channel access according to the COT shared by the other terminal device is executed by the processor to cause the terminal device to perform:
determining, according to a sharing indication indicating COT sharing from the other terminal device, to perform channel access through type 1 LBT, or to perform channel access through type 2 LBT, or to perform no LBT.
